(19) United States
(12) Patent Application Publication
(10) Pub. No.: US 2025/0374207 A1
(43) Pub. Date: Dec. 4, 2025

(54) ELECTRONIC DEVICE FOR PERFORMING WIRELESS COMMUNICATION AND OPERATING METHOD THEREOF

(71) Applicant: Samsung Electronics Co., Ltd., Suwon-si (KR)

(72) Inventor: Hyejeong KIM, Suwon-si (KR)

(21) Appl. No.: 19/291,102

(22) Filed: Aug. 5, 2025

Related U.S. Application Data
(63) Continuation of application No. PCT/KR2024/095277, filed on Feb. 16, 2024.

(30) Foreign Application Priority Data
Feb. 22, 2023 (KR) 10-2023-0023935
Mar. 21, 2023 (KR) 10-2023-0036681

(51) Int. Cl. H04W 52/36; H04W 52/42

(52) U.S. Cl. CPC H04W 52/367; H04W 52/42

(57) ABSTRACT

A device and method for performing wireless communication in an electronic device are provided. The electronic device includes a communication circuit, memory, including one or more storage media, storing instructions, and a processor operatively connected to the communication circuit and the memory, wherein the instructions, when executed by the processor, cause the electronic device to obtain information related to an additional frequency band, transmit data to the external electronic device, identify whether conditions for usage of an additional frequency band are satisfied, based on at least one of a specific absorption rate (SAR) related to the electronic device, internal temperature of the electronic device, or battery consumption, identify whether conditions for switching to the additional frequency band are satisfied, update information related to transmission power of the electronic device, and transmit updated information related to the transmission power of the electronic device.

### CROSS-REFERENCE TO RELATED APPLICATION(S)

This application is a continuation application, claiming priority under 35 U.S.C. § 365(c), of an International application No. PCT/KR2024/095277, filed on Feb. 16, 2024, which is based on and claims the benefit of a Korean patent application number 10-2023-0023935, filed on Feb. 22, 2023, in the Korean Intellectual Property Office, and of a Korean patent application number 10-2023-0036681, filed on Mar. 21, 2023, in the Korean Intellectual Property Office, the disclosure of each of which is incorporated by reference herein in its entirety.

### BACKGROUND

### 1. Field

The disclosure relates to an electronic device for performing wireless communication and an operating method thereof.

### 2. Description of Related Art

To meet the demand for wireless data traffic having increased since deployment of fourth-generation (4G) communication systems, efforts have been made to develop a 5G communication system. Therefore, the fifth-generation (5G) communication system is also called a “beyond 4G network” communication system or a “post long-term evolution (LTE)” system. The 5G communication system is considered to be implemented in 6 GHz or lower bands (e.g., about 3.5 GHz bands) or higher frequency bands (e.g., about 28 GHz bands or about 39 GHz bands), so as to accomplish higher data rates. To decrease propagation loss of the radio waves and increase the transmission distance of radio waves, beamforming, massive multiple-input multiple-output (massive MIMO), full dimensional MIMO (FD-MIMO), array antenna, analog beamforming, and large scale antenna techniques are under discussion in the 5G communication systems.

The above information is presented as background information only to assist with an understanding of the disclosure. No determination has been made, and no assertion is made, as to whether any of the above might be applicable as prior art with regard to the disclosure.

### SUMMARY

In a wireless communication system, the uplink coverage in a cell of a base station may be smaller than the downlink coverage because the transmission power of an electronic device (e.g., user equipment (UE)) is lower than the transmission power of the base station. Since a 5G communication system uses a relatively high first frequency band (e.g., about 3 GHz band to about 6 GHz band), the difference between the uplink coverage and the downlink coverage may be relatively large. In a 5G communication system, the communication quality of the uplink may be degraded in some areas (e.g., cell edge areas) outside the uplink coverage within the cell.

The 5G communication system may use an additional frequency band (e.g., a supplementary uplink (SUL) frequency band), which is a relatively low frequency band (e.g., a band below about 2 GHz), as the uplink frequency band of the electronic device in some areas outside the uplink coverage within the cell.

The 5G communication system may require a method for allocating a relatively high first frequency band or an additional frequency band to the uplink frequency band of the electronic device.

Aspects of the disclosure are to address at least the above-mentioned problems and/or disadvantages and to provide at least the advantages described below. Accordingly, an aspect of the disclosure is to provide a device and method for efficiently selecting an uplink frequency band in an electronic device.

Additional aspects will be set forth in part in the description which follows and, in part, will be apparent from the description, or may be learned by practice of the presented embodiments.

In accordance with an aspect of the disclosure, an electronic device is provided. The electronic device includes a communication circuit, memory, including one or more storage media, storing instructions, and at least one processor operatively connected to the communication circuit and the memory, wherein the instructions, when executed individually or collectively by the at least one processor, cause the electronic device to obtain information related to an additional frequency band from an external electronic device, transmit data to the external electronic device via a first frequency band of a first communication method allocated from the external electronic device, identify whether conditions for usage of an additional frequency band are satisfied, based on at least one of a specific absorption rate (SAR) related to the electronic device, internal temperature of the electronic device, or battery consumption, identify whether conditions for switching to the additional frequency band are satisfied, based on transmission power for the data using the first frequency band of the first communication method in case that it is determined that conditions for usage of the additional frequency band are satisfied, update information related to transmission power of the electronic device in case that it is determined that the conditions for switching to the additional frequency band are satisfied, and transmit updated information related to the transmission power of the external electronic device.

In accordance with another aspect of the disclosure, a method performed by an electronic device is provided. The method includes obtaining information related to an additional frequency band from an external electronic device, transmitting data to the external electronic device via a first frequency band of a first communication method allocated from the external electronic device, identifying whether conditions for usage of an additional frequency band are satisfied, based on at least one of a specific absorption rate (SAR) related to the electronic device, internal temperature of the electronic device, or battery consumption, identifying whether conditions for switching to the additional frequency band are satisfied, based on transmission power for the data using the first frequency band of the first communication method in case that it is determined that conditions for usage of the additional frequency band are satisfied, updating information related to transmission power of the electronic device in case that it is determined that the conditions for switching to the additional frequency band are satisfied, and transmitting updated information related to the transmission power of the external electronic device.

In accordance with another aspect of the disclosure, one or more non-transitory computer-readable storage media storing one or more computer programs including computer-executable instructions that, when executed individually or collectively by one or more processors of an electronic device, cause the electronic device to perform operations are provided. The operations include obtaining information related to an additional frequency band from an external electronic device, transmitting data to the external electronic device via a first frequency band of a first communication method allocated from the external electronic device, identifying whether conditions for usage of an additional frequency band are satisfied, based on at least one of a specific absorption rate (SAR) related to the electronic device, internal temperature of the electronic device, or battery consumption, identifying whether conditions for switching to the additional frequency band are satisfied, based on transmission power for the data using the first frequency band of the first communication method in case that it is determined that conditions for usage of the additional frequency band are satisfied, updating information related to transmission power of the electronic device in case that it is determined that the conditions for switching to the additional frequency band are satisfied, and transmitting updated information related to the transmission power of the external electronic device.

Advantageous effects obtainable from various embodiments of the disclosure may not be limited to the above-mentioned effects, and other effects which are not mentioned herein may be clearly understood through the following description by those skilled in the art to which the disclosure pertains.

According to an embodiment of the disclosure, when an electronic device determines to switch to an additional frequency band (e.g., a SUL frequency band) based on at least one of a specific absorption rate (SAR), an internal temperature of the electronic device, or battery consumption, the electronic device reduces power consumption and/or heating of the electronic device by updating at least one of information related to transmission power (e.g., power headroom) or transmission power to induce selection of an additional frequency band in an external electronic device (e.g., a base station).

According to an embodiment of the disclosure, the electronic device limits unnecessary switching to an additional frequency band by determining whether to switch to the additional frequency band based on the quality (e.g., the strength of the received signal) of the frequency band allocated to the electronic device (e.g., a relatively high first frequency band).

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment according to an embodiment of the disclosure;

FIG. 2 illustrates a wireless communication system using an additional frequency band according to an embodiment of the disclosure;

FIG. 3 illustrates an electronic device using an additional frequency band according to an embodiment of the disclosure;

FIG. 4 is a block diagram of an electronic device using an additional frequency band according to an embodiment of the disclosure;

FIG. 5 is a flowchart for an electronic device to use an additional frequency band according to an embodiment of the disclosure;

FIG. 6 is a flowchart for an electronic device to use an additional frequency band according to an embodiment of the disclosure;

FIG. 7 is a flowchart for an electronic device to determine whether to select an additional frequency band according to an embodiment of the disclosure; and

FIG. 8 is a flowchart for an electronic device to allocate an additional frequency band according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

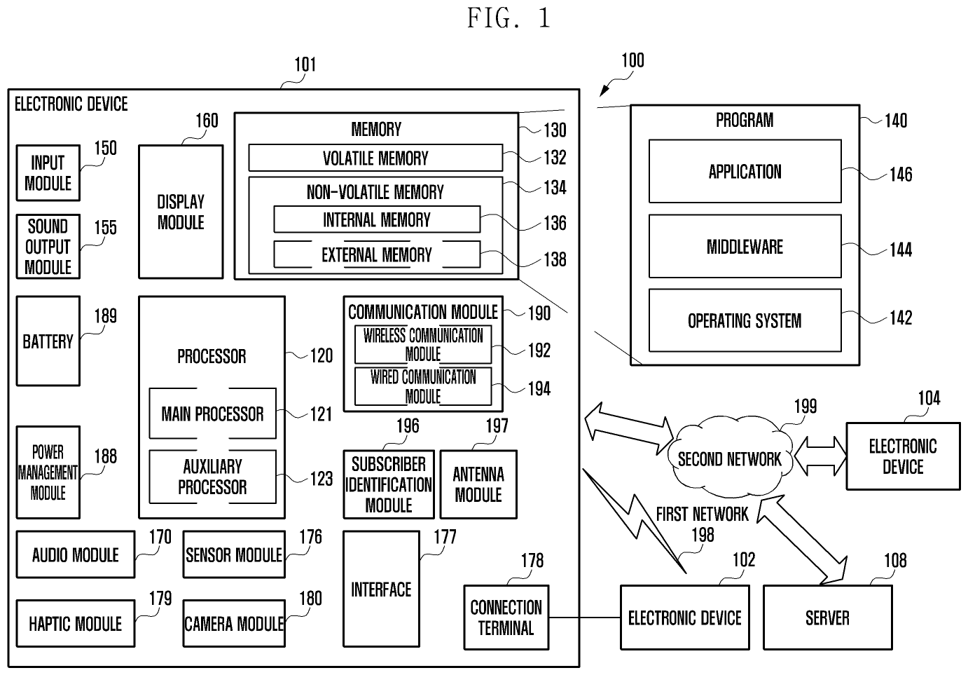

FIG. 1 is a block diagram illustrating an electronic device in a network environment according to an embodiment of the disclosure.

Referring to FIG. 1, an electronic device 101 in a network environment 100 may communicate with an external electronic device 102 via a first network 198 (e.g., a short-range wireless communication network), or at least one of an external electronic device 104 or a server 108 via a second network 199 (e.g., a long-range wireless communication network). According to an embodiment of the disclosure, the electronic device 101 may communicate with the external electronic device 104 via the server 108. According to an embodiment of the disclosure, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments of the disclosure, at least one of the components (e.g., the connecting terminal 178) may be omitted from the electronic device 101, or one or more other components may be added in the electronic device 101. In some embodiments of the disclosure, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment of the disclosure, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment of the disclosure, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., a sleep) state, or together with the main processor 121 while the main processor 121 is in an active state (e.g., executing an application). According to an embodiment of the disclosure, the auxiliary processor 123 (e.g., an image signal processor or a communication processor) may be implemented as part of another component (e.g., the camera module 180 or the communication module 190) functionally related to the auxiliary processor 123. According to an embodiment of the disclosure, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment of the disclosure, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment of the disclosure, the display module 160 may include a touch sensor adapted to detect a touch, or a pressure sensor adapted to measure the intensity of force incurred by the touch.

The audio module 170 may convert a sound into an electrical signal and vice versa. According to an embodiment of the disclosure, the audio module 170 may obtain the sound via the input module 150, or output the sound via the sound output module 155 or a headphone of an external electronic device (e.g., the external electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment of the disclosure, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the external electronic device 102) directly (e.g., wiredly) or wirelessly. According to an embodiment of the disclosure, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the external electronic device 102). According to an embodiment of the disclosure, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment of the disclosure, the haptic module 179 may include, for example, a motor, a piezoelectric element, or an electric stimulator.

The camera module 180 may capture a still image or moving images. According to an embodiment of the disclosure, the camera module 180 may include one or more lenses, image sensors, image signal processors, or flashes.

The power management module 188 may manage power supplied to the electronic device 101. According to an embodiment of the disclosure, the power management module 188 may be implemented as at least part of, for example, a power management integrated circuit (PMIC).

The battery 189 may supply power to at least one component of the electronic device 101. According to an embodiment of the disclosure, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the external electronic device 102, the external electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment of the disclosure, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the external electronic device 104), or a network system (e.g., the second network 199). According to an embodiment of the disclosure, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC. According to one embodiment of the disclosure, the subscriber identification module 196 may include a plurality of subscriber identification modules. For example, the plurality of subscriber identification modules may store different subscriber information.

The antenna module 197 may transmit or receive a signal or power to or from the outside (e.g., the external electronic device) of the electronic device 101. According to an embodiment of the disclosure, the antenna module 197 may include an antenna including a radiating element including a conductive material or a conductive pattern formed in or on a substrate (e.g., a printed circuit board (PCB)). According to an embodiment of the disclosure, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment of the disclosure, another component (e.g., a radio frequency integrated circuit (RFIC)) other than the radiating element may be additionally formed as part of the antenna module 197.

According to various embodiments of the disclosure, the antenna module 197 may form a mmWave antenna module. According to an embodiment of the disclosure, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band. For example, the plurality of antennas may include patch array antennas and/or dipole array antennas.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment of the disclosure, commands or data may be transmitted or received between the electronic device 101 and the external electronic device 104 via the server 108 coupled with the second network 199. Each of the external electronic devices 102 or 104 may be a device of a same type as, or a different type, from the electronic device 101. According to an embodiment of the disclosure, all or some of operations to be executed at the electronic device 101 may be executed at one or more of the external electronic devices 102 or 104 or the server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment of the disclosure, the external electronic device 104 may include an Internet-of-things (IoT) device. The server 108 may be an intelligent server using machine learning and/or a neural network. According to an embodiment of the disclosure, the external electronic device 104 or the server 108 may be included in the second network 199. The electronic device 101 may be applied to intelligent services (e.g., a smart home, a smart city, a smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., wiredly), wirelessly, or via a third element.

As used in connection with various embodiments of the disclosure, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment of the disclosure, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment of the disclosure, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments of the disclosure, each component (e.g., a module or a program) of the above-described components may include a single entity or multiple entities, and some of the multiple entities may be separately disposed in different components. According to various embodiments of the disclosure, one or more of the above-described components may be omitted, or one or more other components may be added. Alternatively or additionally, a plurality of components (e.g., modules or programs) may be integrated into a single component. In such a case, according to various embodiments of the disclosure, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

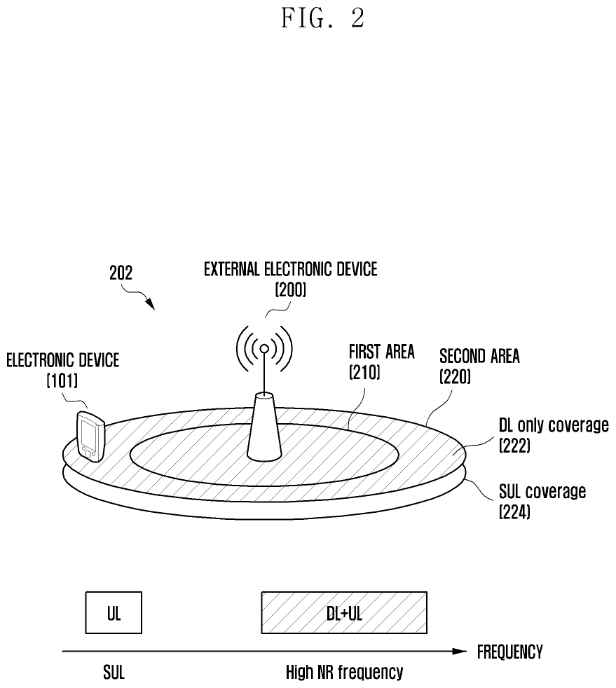

FIG. 2 illustrates a wireless communication system using an additional frequency band according to an embodiment of the disclosure.

Referring to FIG. 2, the wireless communication system may use a supplementary uplink (SUL) to prevent a degradation of communication performance due to a difference between uplink coverage and downlink coverage. For example, the wireless communication system may use an SUL for a first communication method in a non-standalone (NSA) environment by the first communication method (e.g., a new radio (NR) communication method) and a second communication method (e.g., a long term evolution (LTE) communication method). For example, the wireless communication system may use an SUL in a standalone (SA) environment of the first communication method based on frequency range (FR) 1. For example, the wireless communication system may use an SUL in a dual connectivity (DC) or carrier aggregation (CA) environment of the first communication method based on FR 1 and FR 2.

According to an embodiment of the disclosure, when using an SUL, an external electronic device 200 of the wireless communication system may communicate with the electronic device 101 via the first frequency band and the additional frequency band. As an example, the first frequency band may include a first frequency band (e.g., about 3 GHz band to about 6 GHz band) that is relatively high among the frequency bands defined for the first communication method (e.g., NR communication method). As an example, the additional frequency band is a frequency band defined for SUL and may include a lower frequency band (e.g., about 2 GHz or lower band) than the first frequency band. As an example, the external electronic device 200 is a network entity supporting the first communication method, and may represent a base station (e.g., a next generation node B (gNB)) of the first communication method.

According to an embodiment of the disclosure, a cell 202 of the external electronic device 200 may include a first area (e.g., DL+UL coverage) 210 supporting downlink (DL) and uplink (UP) via the first frequency band and a second area 220 that includes an area (e.g., DL only coverage) 222 supporting only downlink (DL) via the first frequency band and an area (e.g., SUL coverage) 224 supporting uplink via the additional frequency band.

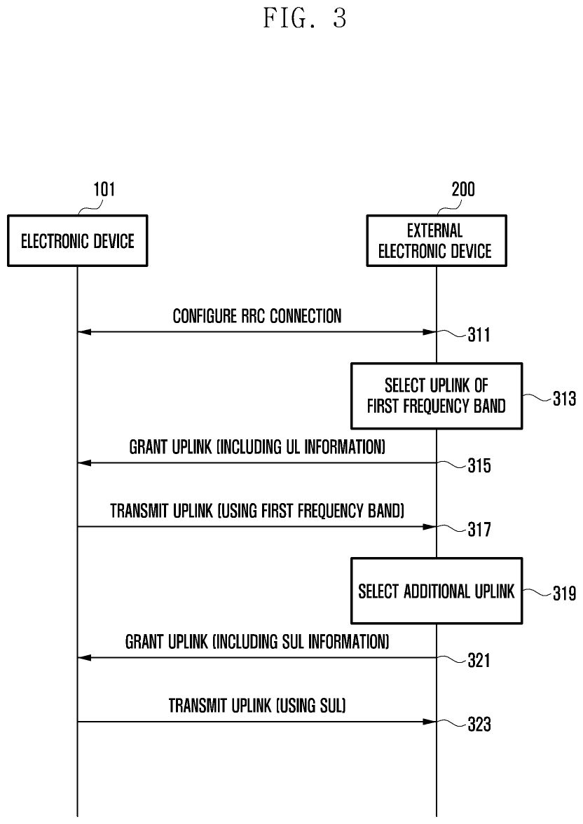

FIG. 3 illustrates an electronic device using an additional frequency band according to an embodiment of the disclosure.

Referring to FIG. 3, when supporting an SUL, the electronic device 101 and the external electronic device 200 may configure the SUL via a radio resource control (RRC) connection setup in operation 311. For example, the external electronic device 200 may transmit information related to the SUL to the electronic device 101 via an RRC reconfiguration message. As an example, information related to the SUL (e.g., “supplementaryUplink”) may be included in “ServingCellConfig” of the RRC reconfiguration message as shown in Table 1 below. As an example, information related to the SUL may include information related to an additional frequency band of the uplink to be used by the electronic device 101.

```
TABLE 1
  ServingCellConfig ::= SEQUENCE {
  tdd-UL-DL-ConfigurationDedicated TDD-UL-DL-
ConfigDedicated OPTIONAL,-- Cond TDD
  initialDownlinkBWP BWP-DownlinkDedicated
OPTIONAL,-- Need M
  downlinkBWP-ToReleaseList SEQUENCE (SIZE
```

| | |
|---|---|
| (1..maxNrofBWPs)) OF BWP-Id | OPTIONAL, -- |

Need N
downlinkBWP-ToAddModList SEQUENCE (SIZE

| | |
|---|---|
| (1..maxNrofBWPs)) OF BWP-Downlink | OPTIONAL, |

```
-- Need N
  firstActiveDownlinkBWP-Id BWP-Id
OPTIONAL,-- Cond SyncAndCellAdd
  bwp-InactivityTimer ENUMERATED
{ms2,ms3,ms4,ms5,ms6,ms8,ms10,ms20,ms30,ms40,
ms50,ms60,ms80,ms100,ms200,ms300,ms500,ms750,ms1280,ms192
0,ms2560,spare10,
spare9,spare8,spare7,spare6,spare5,spare4,spare3,spare2,spare1}OPT
IONAL,--Need R
  defaultDownlinkBWP-Id BWP-Id
OPTIONAL, -- Need S
  uplinkConfig UplinkConfig
OPTIONAL, -- Need M
  supplementaryUplink UplinkConfig
OPTIONAL, -- Need M
  pdcch-ServingCellConfig SetupRelease{PDCCH-
ServingCellConfig} OPTIONAL,-- Need M
  pdsch-ServingCellConfig SetupRelease{PDSCH-
ServingCellConfig} OPTIONAL,-- Need M
  csi-MeasConfig SetupRelease { CSI-MeasConfig }
OPTIONAL, -- Need M
```

According to an embodiment of the disclosure, when the external electronic device 200 selects the first frequency band as the frequency band of the uplink of the electronic device 101 in operation 313, the external electronic device 200 may transmit information related to the first frequency band to the electronic device 101 in operation 315. For example, the external electronic device 200 may select the first frequency band or the additional frequency band as the uplink frequency band of the electronic device 101 based on at least one of the maximum transmission power (max Tx power) of the electronic device 101, information related to transmission power (e.g., power headroom), uplink signal to interference and noise ratio (SINR), uplink error rate (e.g., bit error rate (BER), or path loss. For example, information related to the first frequency band may be included in an uplink grant message and transmitted to the electronic device 101. As an example, the uplink grant message may be included in downlink control information (DCI) (e.g., DCI format 0_0 or DCI format 1_0).

According to an embodiment of the disclosure, the electronic device 101 may transmit data to the external electronic device 200 via the first frequency band based on the information related to the first frequency band received from the external electronic device 200 in operation 317.

According to an embodiment of the disclosure, when the additional frequency band is selected as the uplink frequency band of the electronic device 101 in operation 319, the external electronic device 200 may transmit information related to the additional frequency band (e.g., SUL information) to the electronic device 101 in operation 321. For example, the information related to the additional frequency band may be included in the uplink grant message and transmitted to the electronic device 101. As an example, the uplink grant message may be included in a DCI (e.g., DCI format 0_0 or DCI format 1_0).

According to an embodiment of the disclosure, the electronic device 101 may transmit data to the external electronic device 200 via the additional frequency band based on the information related to the additional frequency band received from the external electronic device 200 in operation 323.

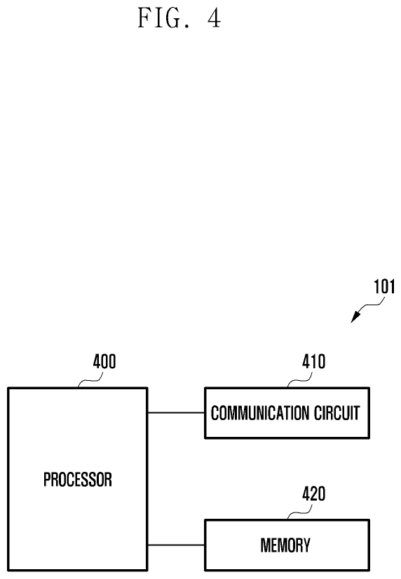

FIG. 4 is a block diagram of an electronic device using an additional frequency band according to an embodiment of the disclosure.

Referring to FIG. 4, the electronic device 101 may be at least partially similar to the electronic device 101 of FIG. 1, 2 or 3, or may include another embodiment of the electronic device.

Referring to FIG. 4, the electronic device 101 may include a processor 400 (e.g., including processing circuitry), a communication circuit 410 (or communication circuitry), and/or memory 420. For example, the processor 400 may be substantially the same as the processor 120 of FIG. 1, or may be included in the processor 120. For example, the communication circuit 410 may be substantially the same as the wireless communication module 192 of FIG. 1, or may be included in the wireless communication module 192. For example, the memory 420 may be substantially the same as the memory 130 of FIG. 1, or may be included in the memory 130. For example, the processor 400 may be operatively, functionally, and/or electrically connected to the communication circuit 410 and/or the memory 420.

According to an embodiment of the disclosure, the processor 400 may identify a SUL configuration. For example, the SUL configuration may be received from the external electronic device 200 via an RRC reconfiguration message in the process of establishing an RRC connection between the electronic device 101 and the external electronic device 200.

According to an embodiment of the disclosure, the processor 400 may configure the uplink frequency band to the first frequency band or the additional frequency band based on the control message received from the external electronic device 200. For example, when the uplink grant message received from the external electronic device 200 includes information related to the first frequency band, the processor 400 may configure the uplink frequency band to the first frequency band. As an example, the information related to the first frequency band may include information indicating that the first frequency band is selected as the frequency band for the uplink. For example, when the uplink grant message received from the external electronic device 200 includes information (or SUL information) related to the additional frequency band, the processor 400 may configure the uplink frequency band to the additional frequency band. As an example, the information related to the additional frequency band may include information indicating that the additional frequency band is selected as the frequency band for the uplink.

According to an embodiment of the disclosure, when the first frequency band is configured to the uplink frequency band, the processor 400 may control the communication circuit 410 to transmit uplink data via the first frequency band. For example, the transmission of uplink data via the first frequency band may include a series of operations of transmitting data to the external electronic device 200 via a frequency (or channel) allocated from the external electronic device 200 within the first frequency band.

According to an embodiment of the disclosure, the processor 400 may identify whether the specified SUL usage condition is satisfied while the first frequency band is configured to the uplink frequency band. For example, the processor 400 may identify whether the specified SUL usage condition is satisfied based on at least one of the specific absorption rate (SAR) of the electronic device 101, the internal temperature of the electronic device 101, or the battery consumption of the electronic device 101. For example, a state of satisfying the specified SUL usage condition may include a state in which the SAR of the electronic device 101 exceeds the specified SAR. As an example, the SAR of the electronic device 101 may include a sum of the SARs of each of the established communication links of the electronic device 101. For example, a state of satisfying the specified SUL usage condition may include a state in which the internal temperature of the electronic device 101 exceeds a specified reference temperature. As an example, the internal temperature of the electronic device 101 may be obtained based on a temperature sensor (not shown) disposed inside the electronic device 101. For example, a state of satisfying the specified SUL usage condition may include a state in which the battery consumption of the electronic device 101 continuously exceeds the specified reference consumption for a specified time period. For example, at least one of the specified SAR, the specified reference temperature, or the specified reference consumption may be configured to a fixed value. For example, at least one of the specified SAR, the specified reference temperature, or the specified reference consumption may be variable based on the environmental state (e.g., whether the electronic device is gripped, or ambient temperature) of the electronic device 101 or the usage history of the SUL. As an example, the usage history of the SUL may include at least one of the SAR of the electronic device 101, the internal temperature of the electronic device 101, or the battery consumption of the electronic device 101 corresponding to the time point when the external electronic device 200 allocates the additional frequency band to the uplink frequency band of the electronic device 101.

According to an embodiment of the disclosure, when it is determined that the specified SUL usage condition is satisfied, the processor 400 may identify whether the specified SUL switching condition is satisfied based on the transmission power of the electronic device 101 based on the first frequency band. As an example, the transmission power of the electronic device 101 based on the first frequency band may include the transmission power of the electronic device 101 used to transmit uplink data via the first frequency band in the first communication method. For example, when the transmission power of the electronic device 101 based on the first frequency band is less than or equal to the specified reference power while satisfying the specified SUL usage conditions, the processor 400 may determine that the transmission power of the second communication method is relatively high and switching to SUL is unnecessary. As an example, a state satisfying the specified SUL switching condition may include a state in which the transmission power of the electronic device 101 based on the first frequency band exceeds the specified reference power. For example, the processor 400 may identify whether the specified SUL switching condition is satisfied based on the difference between the transmission power of the electronic device 101 based on the first frequency band and the transmission power of the electronic device 101 based on the additional frequency band. As an example, a state satisfying the specified SUL switching condition may include a state in which a difference (or difference value) between the transmission power of the electronic device 101 based on the first frequency band and the transmission power of the electronic device 101 based on the additional frequency band exceeds a specified reference power difference (or difference value). As an example, the transmission power of the electronic device 101 based on the additional frequency band may be estimated based on the transmission power of the electronic device 101 in the second communication method of the same frequency band as the additional frequency band. As an example, the transmission power of the electronic device 101 based on the additional frequency band may be estimated based on a measurement result (e.g., inter-frequency measurement) related to the additional frequency band.

For example, the processor 400 may identify whether the specified SUL switching condition is satisfied based on the amount of uplink data transmitted based on the first communication method. As an example, a state satisfying the specified SUL switching condition may include a state in which the transmission amount of uplink data based on the first communication method exceeds the specified reference transmission amount. As an example, the transmission amount of uplink data may include at least one of the ratio (e.g., the TX transmission ratio) of the slot to which uplink data is transmitted relative to the total number of slots or the data storage state (or data storage amount) of the TX buffer.

For example, the processor 400 may identify whether the specified SUL switching condition is satisfied based on motion information (e.g., a moving speed or a moving distance) of the electronic device 101. As an example, a state satisfying the specified SUL switching condition may include a state in which the moving speed of the electronic device 101 is less than or equal to a specified speed. As an example, the moving speed or moving distance of the electronic device 101 may be obtained based on a module (or circuit or device) (e.g., a GPS antenna, an acceleration sensor, and/or a gyro sensor) (not shown) disposed inside the electronic device 101.

According to an embodiment of the disclosure, when it is determined that the specified SUL switching condition is satisfied, the processor 400 may update information (e.g., power headroom) related to the transmission power of the electronic device 101. For example, the information related to transmission power of the electronic device 101 may be updated to the minimum value. For example, the information related to the transmission power of the electronic device 101 may be lowered based on the specified first adjustment value. As an example, the specified first adjustment value may include a reference adjustment value for simultaneously updating (e.g., lowering) the information related to transmission power of the electronic device 101. As an example, the information related to the transmission power of the electronic device 101 may include information related to the amount of transmission power additionally available for transmitting uplink data in addition to the transmission power used by the electronic device 101 to transmit uplink data.

According to an embodiment of the disclosure, the processor 400 may control the communication circuit 410 to transmit updated information (e.g., power headroom) related to the transmission power of the electronic device 101 to the external electronic device 200.

According to an embodiment of the disclosure, when updated information related to the transmission power of the electronic device 101 is transmitted, but no additional frequency band is allocated from the external electronic device 200, the processor 400 may control the communication circuit 410 to repeatedly transmit the updated information related to the transmission power of the electronic device 101 to the external electronic device 200 by a specified number of first reference transmissions.

According to an embodiment of the disclosure, when the number of transmissions of updated information related to the transmission power of the electronic device 101 exceeds the specified number of first reference transmissions, the processor 400 may update the transmission power of the electronic device 101. For example, the transmission power of the electronic device 101 may be updated to the minimum transmission power capable of maintaining a connection with an external electronic device or a specified minimum transmission power. For example, the transmission power of the electronic device 101 may be lowered based on a specified second adjustment value. As an example, the specified second adjustment value may include a reference adjustment value for simultaneously updating (e.g., lowering) the transmission power of the electronic device 101.

According to an embodiment of the disclosure, the processor 400 may control the communication circuit 410 to transmit uplink data to the external electronic device 200 based on the updated transmission power of the electronic device 101.

According to an embodiment of the disclosure, when data is transmitted based on the updated transmission power of the electronic device 101, but no additional frequency band is allocated from the external electronic device 200, the processor 400 may control the communication circuit 410 to repeatedly transmit uplink data to the external electronic device 200 based on the updated transmission power of the electronic device 101 by a specified number of second reference transmissions.

According to an embodiment of the disclosure, when the number of transmissions of data based on the updated transmission power of the electronic device 101 exceeds the specified number of second reference transmissions, the processor 400 may restore information (e.g., power headroom) related to the transmission power of the electronic device 101 and/or the transmission power of the electronic device 101. For example, when the number of transmissions of updated information related to the transmission power of the electronic device 101 exceeds the specified number of first reference transmissions, and the number of transmissions of data based on the updated transmission power of the electronic device 101 exceeds the specified number of second reference transmissions, the processor 400 may determine that the switching to the SUL is limited. The processor 400 may restore information related to the transmission power of the electronic device 101 (e.g., power headroom) and/or the transmission power of the electronic device 101 before updating based on the determination that the switching to the SUL is limited.

According to an embodiment of the disclosure, the communication circuit 410 may allow the electronic device 101 to transmit and/or receive signals and/or data with at least one external electronic device 200 (e.g., the external electronic device 102 or 104 of FIG. 1 or the server 108). For example, the communication circuit 410 may include a radio frequency integrated circuit (RFIC) and/or a radio frequency front end (RFFE) for communication with at least one external electronic device 200.

According to an embodiment of the disclosure, the memory 420 may store various data used by at least one component (e.g., the processor 400 and/or the communication circuit 410) of the electronic device 101. For example, the memory 420 may store various instructions that may be executed by the processor 400.

According to an embodiment of the disclosure, an electronic device (e.g., the electronic device 101 of FIG. 1, 2, 3 or FIG. 4) may include a communication circuit (e.g., the wireless communication module 192 of FIG. 1 or the communication circuit 410 of FIG. 4), at least one processor (e.g., the processor 120 of FIG. 1 or the processor 400 of FIG. 4) operatively connected to the communication circuit and memory (e.g., the memory 130 of FIG. 1 or the memory 204 of FIG. 2) comprising one or more storage media, storing instructions. According to an embodiment of the disclosure, the instructions, when executed by the at least one processor individually or collectively, cause the electronic device to obtain information related to an additional frequency band from an external electronic device (e.g., the external electronic device 200 of FIG. 2). According to an embodiment of the disclosure, the instructions, when executed by the at least one processor individually or collectively, cause the electronic device to transmit data to the external electronic device via a first frequency band of a first communication method allocated from the external electronic device. According to an embodiment of the disclosure, the instructions, when executed by the at least one processor individually or collectively, cause the electronic device to identify whether conditions for usage of an additional frequency band are satisfied, based on at least one of a specific absorption rate (SAR) related to the electronic device, internal temperature of the electronic device, or battery consumption. According to an embodiment of the disclosure, the instructions, when executed by the at least one processor individually or collectively, cause the electronic device to identify whether conditions for switching to the additional frequency band are satisfied, based on transmission power for the data using the first frequency band of the first communication method when it is determined that conditions for usage of the additional frequency band are satisfied. According to an embodiment of the disclosure, the instructions, when executed by the at least one processor individually or collectively, cause the electronic device to update information related to transmission power of the electronic device when it is determined that the conditions for switching to the additional frequency band are satisfied. According to an embodiment of the disclosure, the instructions, when executed by the at least one processor individually or collectively, cause the electronic device to transmit updated information related to the transmission power of the external electronic device.

According to an embodiment of the disclosure, the instructions, when executed by the at least one processor individually or collectively, cause the electronic device to determine that the usage condition is satisfied based on at least one of a state in which the SAR of at least one link established in the electronic device exceeds a specified reference SAR, a state in which the internal temperature exceeds a specified reference temperature, or a state in which the battery consumption of the electronic device continuously exceeds a specified consumption for a specified period of time.

According to an embodiment of the disclosure, the instructions, when executed by the at least one processor individually or collectively, cause the electronic device to determine that the switching condition is satisfied based on at least one of a state in which the transmission power of data using the first frequency band of the first communication method exceeds a specified reference power, or a state in which a difference value between the transmission power of data using the first frequency band of the first communication method and the transmission power (or estimated value of the transmission power) of data using the additional frequency band exceeds a specified reference difference value.

According to an embodiment of the disclosure, the transmission power of data using the additional frequency band may be estimated based on the transmission power of a second communication method or a measurement result related to the additional frequency band.

According to an embodiment of the disclosure, the instructions, when executed by the at least one processor individually or collectively, cause the electronic device to identify whether the switching condition is satisfied additionally considering at least one of the data transmission amount of the electronic device or the motion information of the electronic device.

According to an embodiment of the disclosure, the instructions, when executed by the at least one processor individually or collectively, cause the electronic device to, when the number of transmissions of the updated information related to the transmission power exceeds a specified number of first reference transmissions, update transmission power of data using the first frequency band of the above first communication method, and transmit data to the external electronic device based on the updated transmission power.

According to an embodiment of the disclosure, the instructions, when executed by the at least one processor individually or collectively, cause the electronic device to, when the number of transmissions of data based on the updated transmission power exceeds the number of transmissions of a specified second reference, restore the information related to the transmission power of the electronic device and the transmission power of the electronic device.

According to an embodiment of the disclosure, the instructions, when executed by the at least one processor individually or collectively, cause the electronic device to, when information related to the additional frequency band is obtained from the external electronic device based on transmission of updated information related to the transmission power or transmission of data based on the updated transmission power, transmit data to the external electronic device via the additional frequency band.

According to an embodiment of the disclosure, the instructions, when executed by the at least one processor individually or collectively, cause the electronic device to obtain information related to an additional frequency band from the uplink grant message received from the external electronic device.

According to an embodiment of the disclosure, the first frequency band may include a frequency band higher than the additional frequency band.

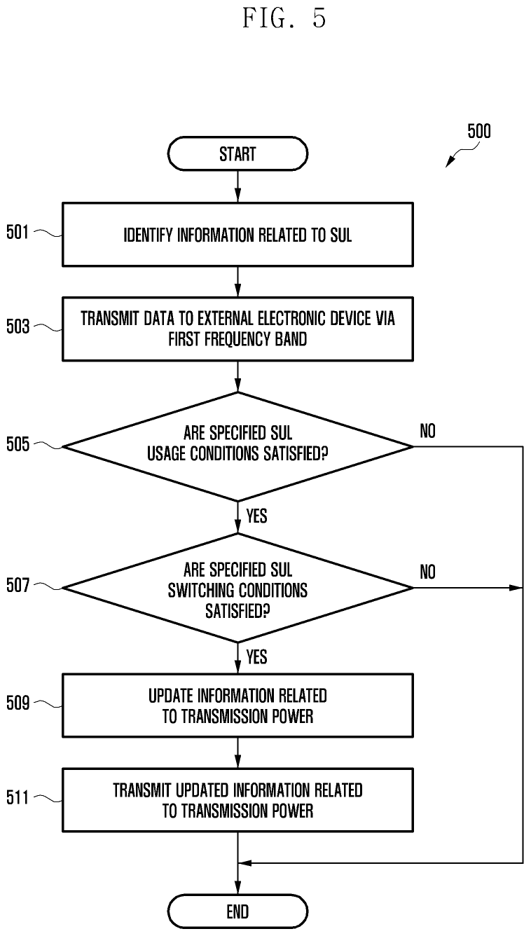

FIG. 5 is a flowchart 500 for an electronic device to use an additional frequency band according to an embodiment of the disclosure.

In the following embodiments of the disclosure, each operation may be performed sequentially, but is not necessarily performed sequentially. For example, the order of each operation may be changed, and at least two operations may be performed in parallel. As an example, the electronic device of FIG. 5 may be the electronic device 101 of FIG. 1, 2, 3, or 4.

Referring to FIG. 5, the electronic device (e.g., the processor 120 of FIG. 1 or the processor 400 of FIG. 4) may identify information related to a supplementary uplink (SUL) in operation 501. For example, the processor 400 may obtain information related to the SUL (e.g., “supplementaryUplink” in Table 1) from an RRC reconfiguration message received from the external electronic device 200. As an example, the information related to the SUL may include information related to an additional frequency band of the uplink to be used by the electronic device 101.

According to an embodiment of the disclosure, the electronic device (e.g., the processor 120 or 400) may transmit data to the external electronic device 200 via the first frequency band in operation 503. For example, when the uplink grant message received from the external electronic device 200 includes information related to the first frequency band, the processor 400 may control the communication circuit 410 to transmit uplink data to the external electronic device 200 via the first frequency band. As an example, the transmission of data (or uplink data) via the first frequency band may include a series of operations of transmitting data to the external electronic device 200 via a frequency (or channel) allocated from the external electronic device 200 within the first frequency band of the first communication method. As an example, the first frequency band may include a relatively high frequency band (e.g., about 3 GHz band to about 6 GHz band) among the frequency bands defined in the first communication method.

According to an embodiment of the disclosure, in operation 505, the electronic device (e.g., the processor 120 or 400) may identify whether the specified SUL usage condition is satisfied based on at least one of the specific absorption rate (SAR) of the electronic device 101, the internal temperature of the electronic device 101, or the battery consumption of the electronic device 101. For example, a state of satisfying the specified SUL usage condition may include a state in which the SAR of the electronic device 101 exceeds the specified SAR. As an example, the SAR of the electronic device 101 may include a sum of the SARs of each of the communication links activated in the electronic device 101. For example, a state of satisfying the specified SUL usage condition may include a state in which the internal temperature of the electronic device 101 exceeds a specified reference temperature. As an example, the internal temperature of the electronic device 101 may be obtained based on a temperature sensor (not shown) disposed inside the electronic device 101. For example, a state of satisfying the specified SUL usage condition may include a state in which the battery consumption of the electronic device 101 continuously exceeds the specified reference consumption for a specified time period. As an example, at least one of the specified SAR, the specified reference temperature, or the specified reference consumption may be configured to a fixed value. As an example, at least one of the specified SAR, the specified reference temperature, or the specified reference consumption may be variable based on the environmental state (e.g., whether the electronic device is gripped, or ambient temperature) of the electronic device 101 or the usage history of the SUL. As an example, the usage history of the SUL may include at least one of the SAR of the electronic device 101, the internal temperature of the electronic device 101, or the battery consumption of the electronic device 101 corresponding to the time point when the external electronic device 200 allocates the additional frequency band to the uplink frequency band of the electronic device 101.

According to an embodiment of the disclosure, when it is determined that the specified SUL use condition is not satisfied (e.g., “No” in operation 505), the electronic device (e.g., processor 120 or 400) may terminate an embodiment for using the additional frequency band. For example, when it is determined that the specified SUL use condition is not satisfied, the processor 400 may determine that the electronic device 101 is located within the uplink coverage (e.g., the first area 210 of FIG. 2) based on the first frequency band. The processor 400 may determine that the use of the additional frequency band is unnecessary based on the determination that the electronic device 101 is located within the uplink coverage (e.g., the first area 210 of FIG. 2) based on the first frequency band.

According to an embodiment of the disclosure, when it is determined that the specified SUL use condition is satisfied (e.g., “Yes” in operation 505), in operation 507, the electronic device (e.g., processor 120 or 400) may identify whether the specified SUL switching condition is satisfied based on the transmission power of the electronic device 101 based on the first frequency band. As an example, the transmission power of the electronic device 101 based on the first frequency band may include the transmission power of the electronic device 101 used to transmit uplink data via the first frequency band in the first communication method.

For example, when the transmission power of the electronic device 101 based on the first frequency band exceeds the specified reference power, the processor 400 may determine that the specified SUL switching condition is satisfied.

For example, when the difference (or difference value) between the transmission power of the electronic device 101 based on the first frequency band and the transmission power of the electronic device 101 based on the additional frequency band exceeds the specified reference power difference (or difference value), the processor 400 may determine that the specified SUL switching condition is satisfied. As an example, the transmission power of the electronic device 101 based on the additional frequency band may be estimated based on the transmission power of the electronic device 101 in the second communication method of the same frequency band as the additional frequency band. As an example, the transmission power of the electronic device 101 based on the additional frequency band may be estimated based on a measurement result (e.g., inter-frequency measurement) related to the additional frequency band.

For example, when the amount of uplink data transmission based on the first communication method exceeds the specified reference transmission amount, the processor 400 may determine that the specified SUL switching condition is satisfied. As an example, the amount of uplink data transmission may include at least one of the ratio (e.g., the TX transmission ratio) of the slot to which uplink data is transmitted relative to the total number of slots or the data storage state (or data storage amount) of the TX buffer.

For example, the processor 400 may identify whether the specified SUL switching condition is satisfied based on motion information (e.g., moving speed or moving distance) of the electronic device 101. As an example, the state satisfying the specified SUL switching condition may include a state in which the moving speed of the electronic device 101 is less than or equal to the specified speed.

According to an embodiment of the disclosure, when it is determined that the specified SUL switching condition is not satisfied (e.g., “No” in operation 507), the electronic device (e.g., processor 120 or 400) may terminate an embodiment for using the additional frequency band. For example, when it is determined that the specified SUL switching condition is not satisfied while the specified SUL usage condition is satisfied, the processor 400 may determine that switching to the SUL (or additional frequency band) is unnecessary.

According to an embodiment of the disclosure, when it is determined that the specified SUL switching condition is satisfied (e.g., “Yes” in operation 507), in operation 509, the electronic device (e.g., processor 120 or 400) may update information (e.g., power headroom) related to the transmission power of the electronic device 101. For example, the information related to transmission power of the electronic device 101 may be updated to the minimum value. For example, the information related to the transmission power of the electronic device 101 may be lowered based on the specified first adjustment value. As an example, the specified first adjustment value may include a reference adjustment value for simultaneously updating (e.g., lowering) the information related to transmission power of the electronic device 101.

According to an embodiment of the disclosure, in operation 511, the electronic device (e.g., processor 120 or 400) may transmit updated information (e.g., power headroom) related to the transmission power of the electronic device 101 to the external electronic device 200.

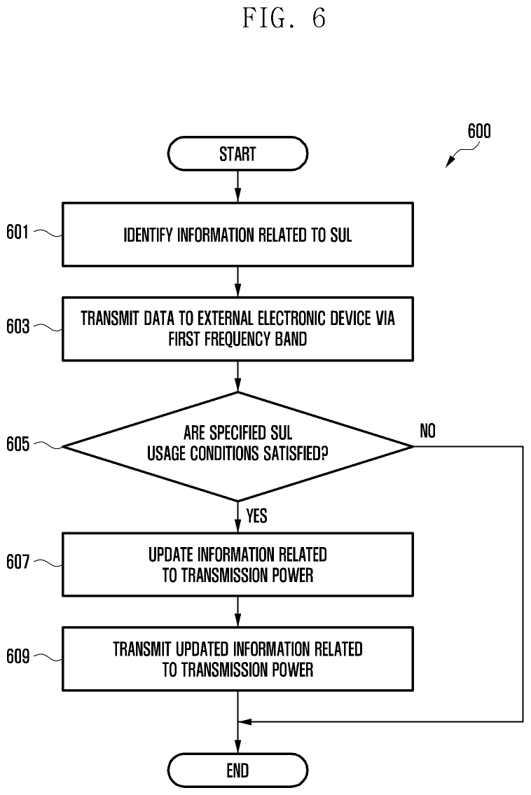

FIG. 6 is a flowchart 600 for an electronic device to use an additional frequency band according to an embodiment of the disclosure.

In the following embodiments of the disclosure, each operation may be performed sequentially, but is not necessarily performed sequentially. For example, the order of each operation may be changed, and at least two operations may be performed in parallel. As an example, the electronic device of FIG. 6 may be the electronic device 101 of FIG. 1, 2, 3, or 4.

Referring to FIG. 6, the electronic device (e.g., the processor 120 of FIG. 1 or the processor 400 of FIG. 4) may identify information related to a SUL in operation 601. For example, the processor 400 may obtain information related to the SUL (e.g., “supplementaryUplink” in Table 1) from an RRC reconfiguration message received from the external electronic device 200. As an example, the information related to the SUL may include information related to an additional frequency band of the uplink to be used by the electronic device 101.

According to an embodiment of the disclosure, the electronic device (e.g., the processor 120 or 400) may transmit data to the external electronic device 200 via the first frequency band in operation 603. For example, when the uplink grant message received from the external electronic device 200 includes information related to the first frequency band, the processor 400 may control the communication circuit 410 to transmit uplink data to the external electronic device 200 via the first frequency band. As an example, the transmission of data (or uplink data) via the first frequency band may include a series of operations of transmitting data to the external electronic device 200 via a frequency (or channel) allocated from the external electronic device 200 within the first frequency band of the first communication method. As an example, the first frequency band may include a relatively high frequency band (e.g., about 3 GHz band to about 6 GHz band) among the frequency bands defined in the first communication method.

According to an embodiment of the disclosure, in operation 605, the electronic device (e.g., the processor 120 or 400) may identify whether the specified SUL use condition is satisfied based on the communication quality corresponding to the first frequency band of the first communication method. For example, a state of satisfying the specified SUL usage condition may include a state in which the communication quality corresponding to the first frequency band of the first communication method exceeds a specified reference communication quality. As an example, the communication quality may include at least one of the received signal strength indicator (RSSI), the reference signal received quality (RSRQ), the reference signal received power (RSRP), the signal to interference and noise ratio (SINR), the bit error rate (BER), the modulation and coding scheme (MCS), the reception data rate, the transmission power (or transmission power), or the transmission data rate. As an example, the specified reference communication quality may be configured to a fixed value. As an example, the specified reference communication quality may be variable based on the usage history of the SUL. As an example, the usage history of the SUL may include the communication quality corresponding to the first frequency band of the first communication method corresponding to the time point at which the external electronic device 200 allocates an additional frequency band to the frequency band of the uplink of the electronic device 101.

According to an embodiment of the disclosure, when it is determined that the specified SUL use condition is not satisfied (e.g., “No” in operation 605), the electronic device (e.g., processor 120 or 400) may terminate an embodiment for using the additional frequency band. For example, when it is determined that the specified SUL use condition is not satisfied, the processor 400 may determine that the electronic device 101 is located within the uplink coverage (e.g., the first area 210 of FIG. 2) based on the first frequency band. The processor 400 may determine that the use of the additional frequency band is unnecessary based on the determination that the electronic device 101 is located within the uplink coverage (e.g., the first area 210 of FIG. 2) based on the first frequency band.

According to an embodiment of the disclosure, when it is determined that the specified SUL usage condition is satisfied (e.g., “Yes” in operation 605), in operation 607, the electronic device (e.g., processor 120 or 400) may update information (e.g., power headroom) related to the transmission power of the electronic device 101. For example, the information related to transmission power of the electronic device 101 may be updated to the minimum value. For example, the information related to the transmission power of the electronic device 101 may be lowered based on the specified first adjustment value. As an example, the specified first adjustment value may include a reference adjustment value for simultaneously updating (e.g., lowering) the information related to transmission power of the electronic device 101.

According to an embodiment of the disclosure, in operation 609, the electronic device (e.g., processor 120 or 400) may transmit updated information (e.g., power headroom) related to the transmission power of the electronic device 101 to the external electronic device 200.

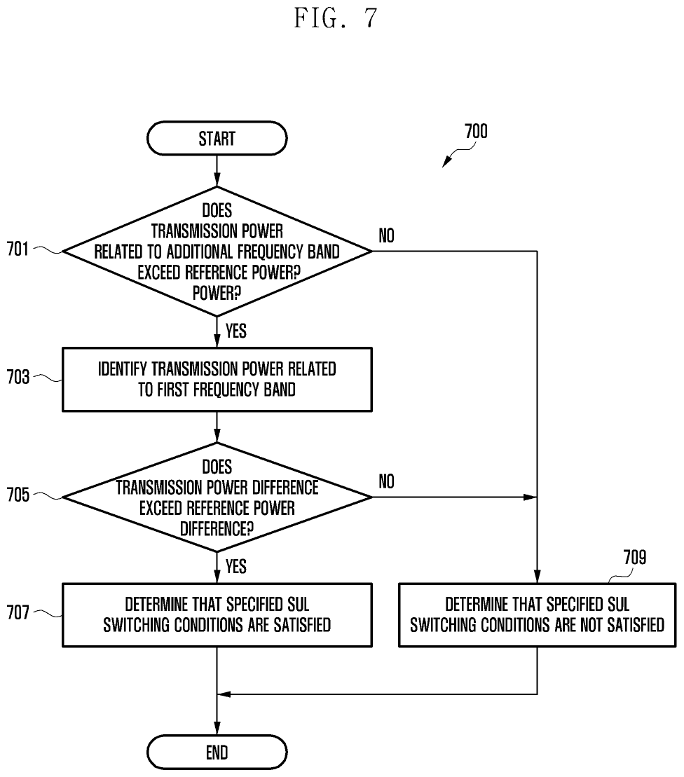

FIG. 7 is a flowchart 700 for an electronic device to determine whether to select an additional frequency band according to an embodiment of the disclosure.

According to an embodiment of the disclosure, at least a part of FIG. 7 may include a detailed operation of operation 507 of FIG. 5. In the following embodiments of the disclosure, each operation may be performed sequentially, but is not necessarily performed sequentially. For example, the order of each operation may be changed, and at least two operations may be performed in parallel. As an example, the electronic device of FIG. 7 may be the electronic device 101 of FIG. 1, 2, 3, or 4.

Referring to FIG. 7, when it is determined that the specified SUL usage condition is satisfied (e.g., “Yes” in operation 505 of FIG. 5), in operation 701, the electronic device (e.g., the processor 120 of FIG. 1 or the processor 400 of FIG. 4) may identify whether the transmission power of the electronic device 101 based on the first frequency band exceeds a specified reference power.

According to an embodiment of the disclosure, when the transmission power of the electronic device 101 based on the first frequency band does not exceed the specified reference power (e.g., “No” in operation 701), in operation 709, the electronic device (e.g., processor 120 or 400) may determine that the specified SUL switching condition is not satisfied. For example, when the transmission power of the electronic device 101 based on the first frequency band is less than or equal to the specified reference power while satisfying the specified SUL usage conditions, the processor 400 may determine that the transmission power of the second communication method (e.g., LTE communication method) is relatively high, and thus the effect (or gain) of lowering the transmission power of the electronic device 101 related to the first communication method via switching to the SUL is relatively low or there is no effect. The processor 400 may determine that the switching to the SUL is unnecessary based on the determination that the gain obtained via the switching to the SUL is relatively low or there is no gain.

According to an embodiment of the disclosure, when the transmission power of the electronic device 101 based on the first frequency band exceeds the specified reference power (e.g., “Yes” in operation 701), in operation 703, the electronic device (e.g., processor 120 or 400) may identify the transmission power of the electronic device 101 related to the additional frequency band. For example, the processor 400 may estimate the transmission power of the electronic device 101 related to the additional frequency band based on the transmission power of the electronic device 101 in the second communication method of the same frequency band (e.g., “B20” frequency band, about 830 MHz to about 860 MHz) as the additional frequency band (e.g., “n82” frequency band) allocated to the electronic device 101 from the external electronic device 200 for SUL in a non-standalone (NSA) environment. For example, the processor 400 may estimate the transmission power of the electronic device 101 related to the additional frequency band based on the measurement result (e.g., inter-frequency measurement) related to the additional frequency band (e.g., “n82” frequency band) allocated to the electronic device 101 from the external electronic device 200 for the SUL.

According to an embodiment of the disclosure, in operation 705, the electronic device (e.g., the processor 120 or 400) may determine whether the difference (or difference value) between the transmission power of the electronic device 101 based on the first frequency band and the transmission power of the electronic device 101 based on the additional frequency band exceeds a specified reference power difference (or difference value).

According to an embodiment of the disclosure, when the difference (or difference value) between the transmission power of the electronic device 101 based on the first frequency band and the transmission power of the electronic device 101 based on the additional frequency band does not exceed the specified reference power difference (or difference value) (e.g., “No” in operation 705), in operation 709, the electronic device (e.g., processor 120 or 400) may determine that the specified SUL switching condition is not satisfied. For example, when the difference (or difference value) between the transmission power of the electronic device 101 based on the first frequency band and the transmission power of the electronic device 101 based on the additional frequency band is less than or equal to the specified reference power difference (or difference value) (e.g., about 3 dB), the processor 400 may determine that the effect (or gain) of lowering the transmission power of the electronic device 101 via switching to the SUL is relatively low or there is no effect. The processor 400 may determine that the switching to the SUL is unnecessary based on the determination that the gain obtained via the switching to the SUL is relatively low or there is no gain.

According to an embodiment of the disclosure, when the difference (or difference value) between the transmission power of the electronic device 101 based on the first frequency band and the transmission power of the electronic device 101 based on the additional frequency band exceeds the specified reference power difference (or difference value) (e.g., “Yes” in operation 705), in operation 707, the electronic device (e.g., processor 120 or 400) may determine that the specified SUL switching condition is satisfied. For example, when the transmission power of the electronic device 101 based on the first frequency band exceeds the specified reference power while satisfying the specified SUL usage condition, the processor 400 may determine that the transmission power of the first communication method (e.g., the NR communication method) is relatively high, and thus the effect (or gain) of lowering the transmission power of the electronic device 101 related to the first communication method may be obtained via switching to the SUL.

For example, when the difference (or difference value) between the transmission power of the electronic device 101 based on the first frequency band and the transmission power of the electronic device 101 based on the additional frequency band exceeds the specified reference power difference (or difference value) (e.g., about 3 dB), the processor 400 may determine that the effect (or gain) of lowering the transmission power of the electronic device 101 related to the first communication method may be obtained via switching to the SUL.

For example, the processor 400 may determine that the switching to the SUL is necessary based on the determination that the gain obtained via switching to the SUL is relatively high.

According to an embodiment of the disclosure, the electronic device 101 (e.g., processor 120 or 400) may additionally consider at least one of the uplink data transmission amount based on the first communication method or the motion information (e.g., moving speed or moving distance) of the electronic device 101 to identify whether the specified SUL switching condition is satisfied.

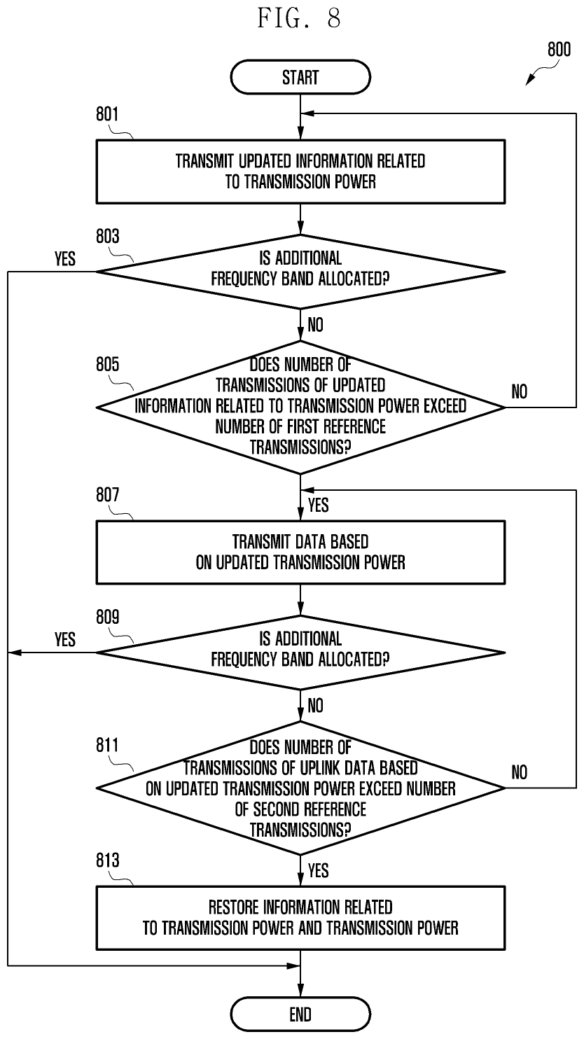

FIG. 8 is a flowchart 800 for an electronic device to allocate an additional frequency band according to an embodiment of the disclosure.

According to an embodiment of the disclosure, at least a part of FIG. 8 may include a detailed operation of operation 511 of FIG. 5. In the following embodiments of the disclosure, each operation may be performed sequentially, but is not necessarily performed sequentially. For example, the order of each operation may be changed, and at least two operations may be performed in parallel. As an example, the electronic device of FIG. 8 may be the electronic device 101 of FIG. 1, 2, 3, or 4.

Referring to FIG. 8, when information (e.g., power headroom) related to the transmission power of the electronic device 101 is updated based on the determination that the specified SUL switching condition is satisfied (e.g., operation 509 of FIG. 5), in operation 801, the electronic device (e.g., the processor 120 of FIG. 1 or the processor 400 of FIG. 4) may transmit the updated information (e.g., power headroom) related to the transmission power of the electronic device 101 to the external electronic device 200. As an example, the information related to the transmission power of the electronic device 101 may include information related to the amount of transmission power additionally available for transmitting uplink data in addition to the transmission power used by the electronic device 101 to transmit uplink data.

According to an embodiment of the disclosure, in operation 803, the electronic device (e.g., the processor 120 or 400) may identify whether an additional frequency band is allocated from the external electronic device 200. For example, the processor 400 may identify whether an uplink grant message including information related to the additional frequency band is received from the external electronic device 200.

According to an embodiment of the disclosure, when the additional frequency band is not allocated (e.g., “No” in operation 803), in operation 805, the electronic device (e.g., processor 120 or 400) may identify whether the number of transmissions of updated information related to the transmission power of the electronic device 101 exceeds a specified number of first reference transmissions. As an example, the specified number of first reference transmissions may indicate the maximum number of transmissions of updated information related to the transmission power of the electronic device 101 for switching to the SUL.

According to an embodiment of the disclosure, when the number of transmissions of updated information related to the transmission power of the electronic device 101 does not exceed the specified number of first reference transmissions (e.g., “No” in operation 805), in operation 801, the electronic device (e.g., processor 120 or 400) may transmit updated information related to the transmission power of the electronic device 101 to the external electronic device 200. For example, when the information related to the transmission power of the electronic device 101 is updated to the minimum value based on the satisfaction of the specified SUL switching condition, the processor 400 may control the communication circuit 401 to repeatedly transmit updated information related to the transmission power of the same electronic device 101. For example, when the information related to the transmission power of the electronic device 101 is updated based on the specified first adjustment value based on the satisfaction of the specified SUL switching condition, the processor 400 may control the communication circuit 401 to transmit information related to the transmission power of the electronic device 101 to the external electronic device 200 additionally updated by the first adjustment value specified to correspond to the number of transmissions of the updated information related to the transmission power of the electronic device 101. As an example, the information related to the transmission power of the electronic device 101 may be updated to the minimum value based on the specified first adjustment value.

According to an embodiment of the disclosure, when the number of transmissions of updated information related to the transmission power of the electronic device 101 exceeds the specified number of first reference transmissions (e.g., “Yes” in operation 805), in operation 807, the electronic device (e.g., processor 120 or 400) may transmit uplink data to the external electronic device 200 based on the updated transmission power of the electronic device 101. For example, the transmission power of the electronic device 101 may be updated to the minimum transmission power capable of maintaining a connection with an external electronic device 200 or a specified minimum transmission power. For example, the transmission power of the electronic device 101 may be lowered based on a specified second adjustment value. As an example, the specified second adjustment value may include a reference adjustment value for simultaneously updating (e.g., lowering) the transmission power of the electronic device 101.

According to an embodiment of the disclosure, in operation 809, the electronic device (e.g., the processor 120 or 400) may identify whether an additional frequency band is allocated from the external electronic device 200. For example, the processor 400 may identify whether an uplink grant message including information related to the additional frequency band is received from the external electronic device 200.

According to an embodiment of the disclosure, when the additional frequency band is not allocated (e.g., “No” in operation 809), in operation 811, the electronic device (e.g., processor 120 or 400) may identify whether the number of transmissions of uplink data based on the updated transmission power of the electronic device 101 exceeds a specified number of second reference transmissions. As an example, the specified number of second reference transmissions may indicate the maximum number of transmissions of uplink data based on the updated transmission power of the electronic device 101 for switching to the SUL.

According to an embodiment of the disclosure, when the number of transmissions of uplink data based on the updated transmission power of the electronic device 101 does not exceed the specified number of second reference transmissions (e.g., “No” in operation 811), in operation 807, the electronic device (e.g., the processor 120 or 400) may transmit uplink data to the external electronic device 200 based on the updated transmission power of the electronic device 101. For example, when the transmission power of the electronic device 101 is updated to the minimum transmission power based on the satisfaction of the specified SUL switching condition, the processor 400 may control the communication circuit 401 to repeatedly transmit uplink data to the external electronic device 200 based on the updated transmission power of the same electronic device 101. For example, when the transmission power of the electronic device 101 is updated based on the specified second adjustment value based on the satisfaction of the specified SUL switching condition, the processor 400 may control the communication circuit 401 to transmit uplink data to the external electronic device 200 based on the transmission power of the electronic device 101 additionally updated by the second adjustment value specified to correspond to the number of transmissions of uplink data based on the updated transmission power of the electronic device 101. As an example, the transmission power of the electronic device 101 may be updated to the minimum transmission power or the specified minimum transmission power capable of maintaining a connection with the external electronic device 200 based on the specified second adjustment value.

According to an embodiment of the disclosure, when the number of transmissions of uplink data based on the updated transmission power of the electronic device 101 exceeds the specified number of second reference transmissions (e.g., “Yes” in operation 811), in operation 813, the electronic device (e.g., the processor 120 or 400) may restore information (e.g., power headroom) related to the transmission power of the electronic device 101 and/or the transmission power of the electronic device 101. For example, when the number of transmissions of updated information related to the transmission power of the electronic device 101 exceeds the first specified number, and the number of transmissions of data based on the updated transmission power of the electronic device 101 exceeds the second specified number, the processor 400 may determine that the switching to the SUL is limited. For example, the processor 400 may restore the information (e.g., power headroom) related to the transmission power of the electronic device 101 and/or the transmission power of the electronic device 101 to before updating based on the determination that the switching to the SUL is limited.

According to an embodiment of the disclosure, when an additional frequency band is allocated (e.g., “Yes” in operation 803 or “Yes” in operation 809), the electronic device (e.g., the processor 120 or 400) may transmit data to the external electronic device 200 via the additional frequency band. For example, when the uplink grant message received from the external electronic device 200 includes information related to the additional frequency band, the processor 400 may control the communication circuit 410 to transmit uplink data to the external electronic device 200 via the additional frequency band. As an example, the transmission of data (or uplink data) via the additional frequency band may include a series of operations of transmitting data to the external electronic device 200 via a frequency (or channel) allocated from the external electronic device 200 within the additional frequency band.

According to an embodiment of the disclosure, when located at the edge of the first area 210 of FIG. 2, the electronic device 101 may transmit uplink data to the external electronic device 200 by using the first frequency band. For example, when the maximum transmission power of the electronic device 101 is about 24 dBm, the electronic device 101 may use transmission power of about 23 dBm via the “n78” frequency band of the first communication method and about 17.5 dBm via the “B20” frequency band of the second communication method at the edge of the first area 210 of FIG. 2.

According to an embodiment of the disclosure, the electronic device 101 may switch the frequency band of the uplink to an additional frequency band at the edge of the first area 210 of FIG. 2 based on operations 501 to 511 of FIG. 5, 601 to 609 of FIG. 6, and/or 801 to 813 of FIG. 8. For example, the electronic device 101 may use transmission power of about 17.5 dBm via the “n82” frequency band of the first communication method based on switching the uplink frequency band of the first communication method to the SUL. When the additional frequency band of the first communication method (e.g., “n82” frequency band) and the frequency band of the second communication method (e.g., “B20” frequency band) are the same, the electronic device 101 may perform communication of the first communication method or the communication of the second communication method according to information related to the frequency band included in the uplink grant message received from the external electronic device 200. In this case, the transmission power of the electronic device 101 may be reduced to about 17.5 dBm.

According to an embodiment of the disclosure, an operating method performed by an electronic device (e.g., the electronic device 101 of FIG. 1, 2, 3 or 4) may obtain information related to an additional frequency band from an external electronic device (e.g., the external electronic device 200 of FIG. 2). According to an embodiment of the disclosure, the operating method performed by an electronic device may include transmitting data to the external electronic device via a first frequency band of a first communication method allocated from the external electronic device. According to an embodiment of the disclosure, the operating method performed by an electronic device may include identifying whether conditions for usage of an additional frequency band are satisfied, based on at least one of a specific absorption rate (SAR) related to the electronic device, internal temperature of the electronic device, or battery consumption. According to an embodiment of the disclosure, the operating method performed by an electronic device may include identifying whether conditions for switching to the additional frequency band are satisfied, based on transmission power for the data using the first frequency band of the first communication method when it is determined that conditions for usage of the additional frequency band are satisfied. According to an embodiment of the disclosure, the operating method performed by an electronic device may include updating information related to transmission power of the electronic device when it is determined that the conditions for switching to the additional frequency band are satisfied. According to an embodiment of the disclosure, the operating method performed by an electronic device may include transmitting updated information related to the transmission power of the external electronic device.

According to an embodiment of the disclosure, the operating method performed by an electronic device may include determining that the usage condition is satisfied based on at least one of a state in which the SAR of at least one link established in the electronic device exceeds a specified reference SAR, a state in which the internal temperature exceeds a specified reference temperature, or a state in which the battery consumption of the electronic device continuously exceeds a specified consumption for a specified period of time.

According to an embodiment of the disclosure, the operating method performed by an electronic device may include determining that the switching condition is satisfied based on at least one of a state in which the transmission power of data using the first frequency band of the first communication method exceeds a specified reference power, or a state in which a difference value between the transmission power of data using the first frequency band of the first communication method and the transmission power (or estimated value of the transmission power) of data using the additional frequency band exceeds a specified reference difference value.

According to an embodiment of the disclosure, in the operating method performed by an electronic device, transmission power of data using the additional frequency band may be estimated based on the transmission power of the second communication method or measurement results related to the additional frequency band.

According to an embodiment of the disclosure, the operating method performed by an electronic device may include identifying whether the switching condition is satisfied additionally considering at least one of the data transmission amount of the electronic device or the motion information of the electronic device.

According to an embodiment of the disclosure, the operating method performed by an electronic device may include updating transmission power of data using the first frequency band of the above first communication method when the number of transmissions of the updated information related to the transmission power exceeds a specified number of first reference transmissions, and transmitting data to the external electronic device based on the updated transmission power.

According to an embodiment of the disclosure, the operating method performed by an electronic device may include restoring the information related to the transmission power of the electronic device and the transmission power of the electronic device when the number of transmissions of data based on the updated transmission power exceeds the number of transmissions of a specified second reference.

According to an embodiment of the disclosure, the operating method performed by an electronic device may include transmitting data to the external electronic device via the additional frequency band when information related to the additional frequency band is obtained from the external electronic device based on transmission of updated information related to the transmission power or transmission of data based on the updated transmission power.

It will be appreciated that various embodiments of the disclosure according to the claims and description in the specification can be realized in the form of hardware, software or a combination of hardware and software.

Any such software may be stored in non-transitory computer-readable storage media. The non-transitory computer-readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a communication circuit;
memory, comprising one or more storage media, storing instructions; and
at least one processor operatively connected to the communication circuit and the memory,
wherein the instructions, when executed by the at least one processor individually or collectively, cause the electronic device to:
obtain information related to an additional frequency band from an external electronic device,
transmit data to the external electronic device via a first frequency band of a first communication method allocated from the external electronic device,
identify whether conditions for usage of an additional frequency band are satisfied, based on at least one of a specific absorption rate (SAR) related to the electronic device, or internal temperature of the electronic device,
identify whether conditions for switching to the additional frequency band are satisfied, based on transmission power for the data using the first frequency band of the first communication method in case that it is determined that conditions for usage of the additional frequency band are satisfied,
update information related to transmission power of the electronic device in case that it is determined that the conditions for switching to the additional frequency band are satisfied, and
transmit updated information related to the transmission power of the external electronic device.

2. The electronic device of claim 1, wherein the instructions, when executed by the at least one processor individually or collectively, further cause the electronic device to determine that the usage condition is satisfied, based on at least one of:
a state in which the SAR of at least one link established in the electronic device exceeds a specified reference SAR, or
a state in which the internal temperature exceeds a specified reference temperature.

3. The electronic device of claim 1, wherein the instructions, when executed by the at least one processor individually or collectively, further cause the electronic device to determine that the switching condition is satisfied, based on at least one of:
a state in which the transmission power of data using the first frequency band of the first communication method exceeds a specified reference power, or
a state in which a difference value between the transmission power of data using the first frequency band of the first communication method and the transmission power of data using the additional frequency band exceeds a specified reference difference value.

4. The electronic device of claim 3, wherein the transmission power of data using the additional frequency band is estimated based on the transmission power of a second communication method or a measurement result related to the additional frequency band.

5. The electronic device of claim 3, wherein the instructions, when executed by the at least one processor individually or collectively, further cause the electronic device to identify whether the switching condition is satisfied, additionally considering at least one of the data transmission amount of the electronic device or motion information of the electronic device.

6. The electronic device of claim 1, wherein the instructions, when executed by the at least one processor individually or collectively, further cause the electronic device to:
update transmission power of data using the first frequency band of the above first communication method in case that a number of transmissions of the updated information related to the transmission power exceeds a specified number of first reference transmissions, and
transmit data to the external electronic device, based on the updated transmission power.

7. The electronic device of claim 6, wherein the instructions, when executed by the at least one processor individually or collectively, further cause the electronic device to restore the information related to the transmission power of the electronic device and the transmission power of the electronic device in case that the number of transmissions of data based on the updated transmission power exceeds the number of transmissions of a specified second reference.

8. The electronic device of claim 7, wherein the instructions, when executed by the at least one processor individually or collectively, further cause the electronic device to transmit data to the external electronic device via the additional frequency band in case that information related to the additional frequency band is obtained from the external electronic device based on transmission of updated information related to the transmission power or transmission of data based on the updated transmission power.

9. A method performed by an electronic device, the method comprising:
obtaining information related to an additional frequency band from an external electronic device;
transmitting data to the external electronic device via a first frequency band of a first communication method allocated from the external electronic device;
identifying whether conditions for usage of an additional frequency band are satisfied, based on at least one of a specific absorption rate (SAR) related to the electronic device, or internal temperature of the electronic device;
identifying whether conditions for switching to the additional frequency band are satisfied, based on transmission power for the data using the first frequency band of the first communication method in case that it is determined that conditions for usage of the additional frequency band are satisfied;
updating information related to transmission power of the electronic device in case that it is determined that the conditions for switching to the additional frequency band are satisfied; and
transmitting updated information related to the transmission power of the external electronic device.

10. The method of claim 9, further comprising:
determining that the usage condition is satisfied, based on at least one of:
a state in which the SAR of at least one link established in the electronic device exceeds a specified reference SAR, or
a state in which the internal temperature exceeds a specified reference temperature.

11. The method of claim 9, further comprising:
determining that the switching condition is satisfied, based on at least one of:
a state in which the transmission power of data using the first frequency band of the first communication method exceeds a specified reference power, or
a state in which a difference value between the transmission power of data using the first frequency band of the first communication method and the transmission power of data using the additional frequency band exceeds a specified reference difference value.

12. The method of claim 11, further comprising:
identifying whether the switching condition is satisfied, additionally considering at least one of the data transmission amount of the electronic device or motion information of the electronic device.

13. The method of claim 9, further comprising;
updating transmission power of data using the first frequency band of the above first communication method in case that a number of transmissions of the updated information related to the transmission power exceeds a specified number of first reference transmissions; and
transmitting data to the external electronic device, based on the updated transmission power.

14. The method of claim 13, further comprising:
restoring the information related to the transmission power of the electronic device and the transmission power of the electronic device in case that the number of transmissions of data based on the updated transmission power exceeds the number of transmissions of a specified second reference.

15. The method of claim 14, further comprising:
transmitting data to the external electronic device via the additional frequency band in case that information related to the additional frequency band is obtained from the external electronic device based on transmission of updated information related to the transmission power or transmission of data based on the updated transmission power.

16. The method of claim 11, further comprising:
estimating the transmission power of data using the additional frequency band based on the transmission power of a second communication method or a measurement result related to the additional frequency band.

17. One or more non-transitory computer-readable storage media storing one or more computer programs including computer-executable instructions that, when executed by a processor of an electronic device individually or collectively, cause the electronic device to perform operations, the operations comprising:
obtaining information related to an additional frequency band from an external electronic device;
transmitting data to the external electronic device via a first frequency band of a first communication method allocated from the external electronic device;
identifying whether conditions for usage of an additional frequency band are satisfied, based on at least one of a specific absorption rate (SAR) related to the electronic device, or internal temperature of the electronic device;
identifying whether conditions for switching to the additional frequency band are satisfied, based on transmission power for the data using the first frequency band of the first communication method in case that it is determined that conditions for usage of the additional frequency band are satisfied;
updating information related to transmission power of the electronic device in case that it is determined that the conditions for switching to the additional frequency band are satisfied; and
transmitting updated information related to the transmission power of the external electronic device.

18. The one or more non-transitory computer-readable storage media of claim 17, further comprising:
determining that the usage condition is satisfied, based on at least one of:
a state in which the SAR of at least one link established in the electronic device exceeds a specified reference SAR, or
a state in which the internal temperature exceeds a specified reference temperature.
